(19) United States
(12) Patent Application Publication
(10) Pub. No.: US 2012/0147589 A1
(43) Pub. Date: Jun. 14, 2012

(54) System for Providing a Directional LED Array

(76) Inventor: Todd Farmer, Livermore, CA (US)

(21) Appl. No.: 13/086,158

(22) Filed: Apr. 13, 2011

Related U.S. Application Data
(60) Provisional application No. 61/423,025, filed on Dec. 14, 2010.

(51) Int. Cl. F21V 7/00; F21V 9/16

(52) U.S. Cl. 362/84; 362/227; 362/235

(57) ABSTRACT

System for providing a directional LED array. In an aspect, a directional LED array is provided that includes a plurality of LEDs and a plurality of cups coupled to the plurality of LEDs and configured to direct light emitted from the plurality of LEDs into a resulting array beam pattern, wherein each cup directs light from one or more LEDs to form the resulting array beam pattern. In another aspect, a lighting device is provided that includes a lighting fixture and a cup array coupled to the lighting fixture. The cup array includes a plurality of LEDs and a plurality of cups coupled to the plurality of LEDs and configured to direct light emitted from the plurality of LEDs into a resulting array beam pattern, wherein each cup directs light from one or more LEDs to form the resulting array beam pattern.

### CLAIM OF PRIORITY UNDER 35 U.S.C. §119

This patent application claims the benefit of priority from U.S. Provisional Patent Application No. 61/423,025 entitled “DIRECTIONAL LED ARRAY” filed on Dec. 14, 2010 and assigned to the assignee hereof and hereby expressly incorporated by reference herein.

### BACKGROUND

1. Field

The present application relates generally to light emitting diodes, and more particularly, to a system for providing a directional LED array.

2. Background

A light emitting diode (LED) comprises a semiconductor material impregnated, or doped, with impurities. These impurities add “electrons” and “holes” to the semiconductor, which can move in the material relatively freely. Depending on the kind of impurity, a doped region of the semiconductor can have predominantly electrons or holes, and is referred to as an n-type or p-type semiconductor region, respectively.

In LED applications, an LED semiconductor chip includes an n-type semiconductor region and a p-type semiconductor region. A reverse electric field is created at the junction between the two regions, which causes the electrons and holes to move away from the junction to form an active region. When a forward voltage sufficient to overcome the reverse electric field is applied across the p-n junction, electrons and holes are forced into the active region and combine. When electrons combine with holes, they fall to lower energy levels and release energy in the form of light. The ability of LED semiconductors to emit light has allowed these semiconductors to be used in a variety of lighting devices. For example, LED semiconductors may be used in general lighting devices for interior or exterior applications.

Various techniques have been tried to improve the light output and directionality LED arrays. For example, a conventional array of LEDs will normally create a round beam pattern. One technique to control directionality uses a lens that covers the entire LED array in an attempt to extract light and control directionality. Unfortunately, this technique is not very effective in controlling directionality or beam pattern generation. For example, it is desirable to have an LED array that can form different types of beam patterns other than circular patterns, such as rectangular beam patterns.

Accordingly, what is needed is a simple and cost efficient way to control the directionality and beam patterns of LED arrays.

### SUMMARY

In various aspects, a directional LED array is provided that produces highly directional light. The directional LED array utilizes one or more directional cups to provide highly directional light from the LED array. Each cup can be shaped to direct the light emitted from one or more LEDs in a desired direction. The cups comprise a reflective surface that further assists in directing light to increase the overall light output. Thus, the directional LED array provides highly directional light and can be configured to form any desired beam pattern, such as round, oval, rectangular, or square beam patterns.

In an aspect, a directional LED array is provided that comprises a plurality of LEDs and a plurality of cups coupled to the LEDs and configured to direct light emitted from the plurality of LEDs into a resulting array beam pattern, wherein each cup directs light from one or more LEDs to form the resulting array beam pattern.

In an aspect, a lighting device is provided that comprises a lighting fixture and a directional cup array coupled to the lighting fixture and comprising a plurality of LEDs and a plurality of cups configured to direct light emitted from the plurality of LEDs into a resulting array beam pattern, wherein each cup directs light from one or more LEDs to form the resulting array beam pattern.

In an aspect, a cup apparatus is provided that comprises a plurality of cups configured to direct light emitted to form a resulting array beam pattern, wherein each cup directs light from one or more LEDs to form the resulting array beam pattern, and one or more mounting surfaces disposed on the plurality of cups, wherein the one or more mounting surfaces are configured to mount the plurality of cups in a position to receive the light from the one or more LEDs.

It is understood that aspects of the present invention will become readily apparent to those skilled in the art from the following detailed description. As will be realized, the present invention includes other and different aspects and its several details are capable of modification in various other respects, all without departing from the spirit and scope of the present invention. Accordingly, the Drawings and Description are to be regarded as illustrative in nature and not as restrictive.

### BRIEF DESCRIPTION OF THE DRAWINGS

The foregoing aspects described herein will become more readily apparent by reference to the following Description when taken in conjunction with the accompanying drawings wherein:

FIG. 1 shows top, front, and side views of an exemplary directional cup;

FIG. 2 shows cross sectional views of exemplary directional cups and their associated beam patterns;

FIG. 3 shows a perspective view of an exemplary directional cup;

FIG. 4 shows a cross-sectional side view of an exemplary directional cup array comprising three directional cups;

FIG. 5 shows a cross-sectional side view of an exemplary directional cup;

FIG. 6 shows a cross-sectional side view of an exemplary directional cup;

FIG. 7 shows two exemplary directional cup arrays;

FIG. 8 shows an exemplary beam pattern associated with an exemplary directional cup;

FIG. 9 shows an exemplary directional cup array; and

FIG. 10 shows an exemplary lighting fixture comprising a directional cup array.

### DESCRIPTION

The present invention is described more fully hereinafter with reference to the accompanying drawings, in which various aspects of the present invention are shown. This invention may, however, be embodied in many different forms and should not be construed as limited to the various aspects presented throughout this disclosure. Rather, these aspects are provided so that this disclosure will be thorough and complete, and will fully convey the scope of the present invention to those skilled in the art. The various aspects of the present invention illustrated in the drawings may not be drawn to scale. Accordingly, the dimensions of the various features may be expanded or reduced for clarity. In addition, some of the drawings may be simplified for clarity. Thus, the drawings may not depict all of the components of a given apparatus (e.g., device) or method.

Various aspects of the present invention will be described herein with reference to drawings that are schematic illustrations of idealized configurations of the present invention. As such, variations from the shapes of the illustrations as a result, for example, manufacturing techniques and/or tolerances, are to be expected. Thus, the various aspects of the present invention presented throughout this disclosure should not be construed as limited to the particular shapes of elements (e.g., regions, layers, sections, substrates, etc.) illustrated and described herein but are to include deviations in shapes that result, for example, from manufacturing. By way of example, an element illustrated or described as a rectangle may have rounded or curved features and/or a gradient concentration at its edges rather than a discrete change from one element to another. Thus, the elements illustrated in the drawings are schematic in nature and their shapes may not be intended to illustrate the precise shape of an element and are not intended to limit the scope of the present invention.

It will be understood that when an element such as a region, layer, section, substrate, or the like, is referred to as being “on” another element, it can be directly on the other element or intervening elements may also be present. In contrast, when an element is referred to as being “directly on” another element, there are no intervening elements present. It will be further understood that when an element is referred to as being “formed” on another element, it can be grown, deposited, etched, attached, connected, coupled, or otherwise prepared or fabricated on the other element or an intervening element.

Furthermore, relative terms, such as “lower” or “bottom” and “upper” or “top,” may be used herein to describe one element's relationship to another element as illustrated in the drawings. It will be understood that relative terms are intended to encompass different orientations of an apparatus in addition to the orientation depicted in the Drawings. By way of example, if an apparatus in the Drawings is turned over, elements described as being on the “lower” side of other elements would then be oriented on the “upper” sides of the other elements. The term “lower”, can therefore, encompass both an orientation of “lower” and “upper,” depending of the particular orientation of the apparatus. Similarly, if an apparatus in the drawing is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items

It will be understood that although the terms “first” and “second” may be used herein to describe various regions, layers and/or sections, these regions, layers and/or sections should not be limited by these terms. These terms are only used to distinguish one region, layer or section from another region, layer or section. Thus, a first region, layer or section discussed below could be termed a second region, layer or section, and similarly, a second region, layer or section may be termed a first region, layer or section without departing from the teachings of the present invention.

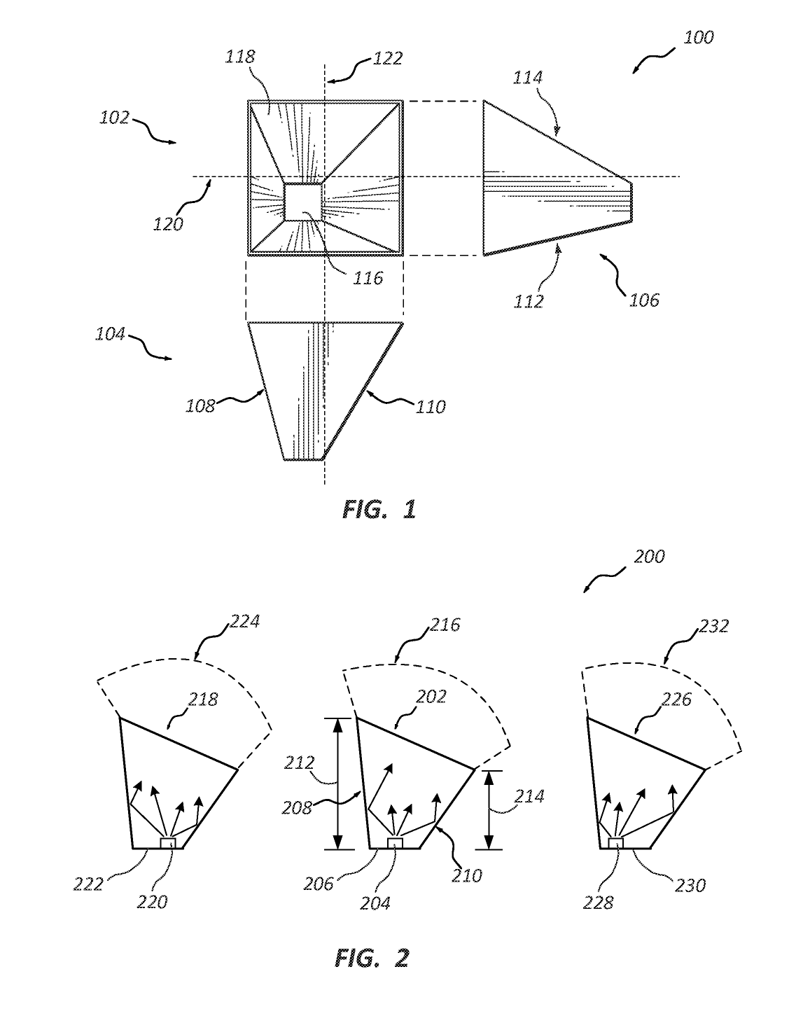

FIG. 1 shows top, front, and side views of an exemplary directional cup 100. For example, the cup 100 is shown in top 102, front 104 and side 106 views. Referring the front view 104, the cup 100 comprises first and second side walls 108 and 110. Referring the side view 106, the cup 100 comprises third and fourth side walls 112 and 114. As illustrated in the top view 102, the side walls 108, 110, 112, and 114 are configured to form a rectangular cup shape. The cup 100 also comprises a bottom portion 116.

Although the cup 100 comprises a rectangular shape, the cup may also be formed to comprise any desired cup geometry. For example, the cup 100 comprises at least one geometry selected from a set of geometries comprising round, oval, elliptical, parabolic, square, triangular, spherical, and/or other multisided geometries. The cup 100 can comprise a variety of materials, for example, aluminum, ceramic, copper, and/or composite materials. In various implementations, the cup 100 can be formed from a variety of processes, such as molding, shaping, stamping, etching or other processes.

Each of the side walls 108, 110, 112, and 114 comprise a reflective surface 118. For example, the reflective surface 118 may be formed by polishing or texturing the side walls or may result from the application of a reflective material onto the side walls. For example, the side walls may be coated or painted to provide a reflective surface.

As further illustrated in the top view 102, the bottom portion 116 is not centered at the bottom of the cup 100. For example, the position of the bottom portion 116 is shifted with respect to the center lines 120 and 122. In various implementations, a light emission location is determined that identifies a location where light is to be emitted into the cup 100. For example, in various implementations, the light emission location is located at one or more of the side walls. For example, an LED may be mounted to one or more of the side walls 108, 110, 112, and 114 to emit light into the cup 100. In another implementation, the light emission location is at the bottom portion 116 and represents the location where one or more LEDs are positioned at the bottom of the cup 100. As discussed below, the formation of the side walls and the location of the LED at the bottom of the cup provide a mechanism to direct light emitted from the LED to form a particular beam pattern.

FIG. 2 shows cross sectional views of exemplary directional cups 200 and their associated cup beam patterns. For example, the cups 200 comprise rectangular configurations having side walls of different heights which affect the resulting cup beam patterns. Furthermore, each of the cups 200 comprises an LED at a different location on its bottom surface, which also affects the resulting cup beam patterns. For example, using the principles of reflection, light emitted from the LED at the bottom of a cup strikes the side walls at an angle of incidence and is reflected at an equal angle of reflection. Thus, the cups 200 illustrate how the principles of reflection can be used to control the shape of the resulting cup beam patterns by controlling the configuration of the cup geometries and the positions of the LEDs at the bottom of the cups.

The cup 202 comprises an LED 204 mounted at the center of the bottom portion 206. The cup 202 comprises a first side wall 208 that is taller than a second side wall 210. For example, the wall 208 has a height 212 that is greater than the height 214 of the side wall 210. Due to the side wall geometry, light emitted from the LED will be reflected off the side walls and result in a cup beam pattern 216. Since the LED 204 is located at the center of the bottom portion 206, the resulting cup beam pattern is due primarily to the side wall geometry (i.e., angles, heights, shapes, etc.).

The cup 218 comprises an LED 220 that is mounted on a bottom surface 222. The LED 220 is mounted to the bottom surface 222 at a position that is shifted toward the right side of the cup 218. As a result, the cup beam pattern 224 formed by the light emitted from the LED 220 and reflected off the side walls is extended on the left side of the cup and compressed on the right side of the cup when compared with the cup beam pattern 216 associated with the cup 202.

The cup 226 comprises an LED 228 that is mounted on a bottom surface 230. The LED 228 is mounted to the bottom surface 230 at a position that is shifted toward the left side of the cup 226. Thus, the LED is mounted to the left of the center of the bottom portion. As a result, the cup beam pattern 232 formed by the light emitted from the LED 228 and reflected off the side walls is extended on the right side of the cup and compressed on the left side of the cup when compared with the cup beam pattern 216 associated with the cup 202.

Thus, in various implementations, the cup geometry (i.e., side wall heights, angles, shapes, etc.) and LED location within each cup operate to control the beam pattern that is generated.

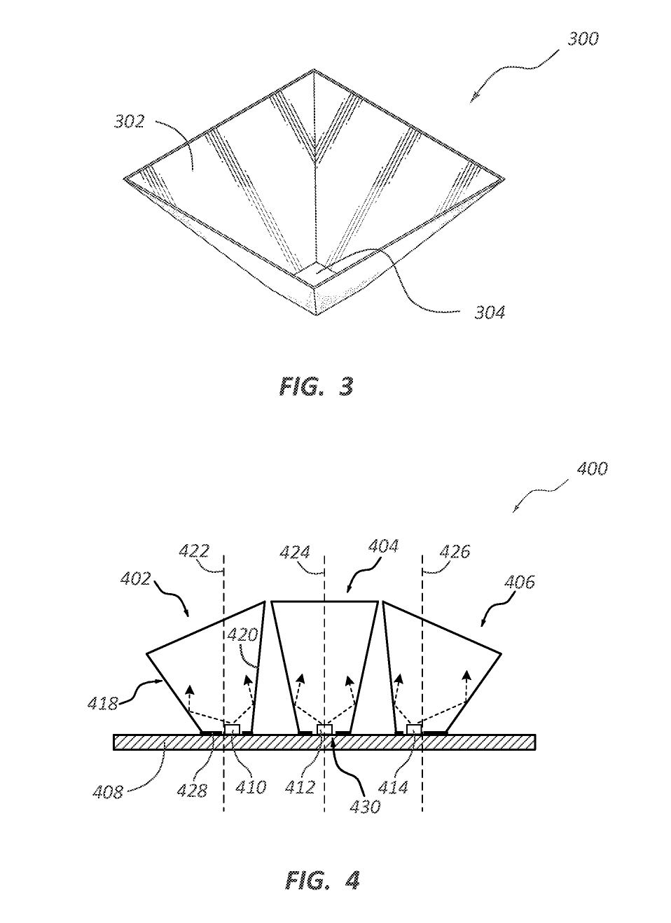

FIG. 3 shows a perspective view of an exemplary directional cup 300. For example, the cup 300 comprises side walls having reflective surface 302 and a bottom portion 304 for directly mounting an LED. In another implementation, the bottom portion 304 comprises a cut away or opening that is configured to expose an LED that is mounted on a substrate and protrudes through the opening when the cup 300 is also mounted to the substrate.

FIG. 4 shows a cross-sectional side view of an exemplary directional cup array 400 comprising three directional cups. For example, the array 400 is suitable for use in an exterior or interior lighting fixture to provide a directed beam pattern of light.

The array 400 is mounted to a substrate 408 onto which are mounted LED 410, LED 412, and LED 414. The substrate 408 comprises electrical connection mechanism, such as copper traces and electrical contacts that provide power and other signals to operate the LEDs to emit light.

The array 400 also comprises three directional cups 402, 404 and 406. Each directional cup comprises a geometric shape with associated side walls that are configured to reflect light to form a particular cup beam pattern. For example, the cup 402 comprises side walls 418 and 420 to direct light emitted from the LED 410 to form a particular cup beam pattern. In various implementations, the side walls may have varying heights and/or shapes, and comprise reflective surfaces to reflect light emitted from the LED 410. For example, in various implementations, the side walls may form a cup having a round, oval, or a multisided geometric shape. For example, the geometric shapes comprise triangular, rectangular or other multisided configurations. The side walls also comprise reflective interior surfaces to facilitate light reflection. The cups 402, 404, and 406 may be formed individually or as an integrated group. For example, the cups 402, 404, and 406 may be molded or stamped together to form an integrated cup assembly that is mounted to the substrate 408.

The cups 402, 404 and 406 also comprise a bottom surface that is configured to provide a light emission location to allow locating an LED that is to emit light within each cup. For example, the bottom surface may comprise an opening (or cut away) to allow an LED mounted on the substrate 408 to be exposed (or protrude) through the bottom of the cup to emit light within the cup. For example, in cup 402, an opening at the bottom of the cup allows the LED 410 to protrude into the cup to emit light within the cup. In cup 404, the opening 430 is configured to locate the LED approximately at the center line 424 of the cup. However, at cup 406, the opening is configured to locate the LED to the right of the center line 426.

To mount the cups to the substrate 408 and provide the correction LED location at the bottom of each cup, a mounting surface is disposed on the bottom surface of the cups to allow the cups to be mounted to the substrate 408 and have their corresponding LEDs be exposed through their associated cut away. For example, the mounting surface 428 allows the cup 402 to mount to the substrate 408 and includes a cut-away or opening in such a position as to allow the LED 410 to extend into the bottom portion of the cup 402. The light emitted from the LED 410 is able to reflect off the interior surface of the side walls 418 and 420 and is focused into a desired beam pattern.

Thus, the array 400 comprises three cups configured to direct light emitted from a plurality of LEDs into a resulting array beam pattern. Each cup directs light from one or more LEDs to form its respective cup beam pattern that is combined with other cup beam patterns to form the resulting array beam pattern. The array 400 includes one or more mounting surfaces that are configured to mount the plurality of cups in a position to receive the light from the one or more LEDs. In one implementation, the array 400 is preformed, stamped, molded or otherwise manufactured and then mounted onto the substrate 408 using the mounting surfaces.

FIG. 5 shows a cross-sectional side view of an exemplary directional cup 500. In this example, a substrate 510 is provided with electrical connections 518 coupled to energize an LED 504. Additional substrate material 514 is layered on top of the substrate 510. The additional substrate material 514 may be aluminum or other material. A directional cup is then formed by the removal of portions of the additional substrate 514 to produce the desired cup geometry. For example, the substrate 514 may be drilled, etched, or the material removed in any other way to form the desired cup geometry and expose the electrical connections 518 on the substrate 510. The LED 504 is then mounted to the substrate 510 so that it is connected to the electrical contacts 518 and can be energized.

The directional cup 500 comprises side wall 502 that surrounds an LED 504 that is mounted to a substrate 510. The side wall 502 forms a shape that is used to direct the light emitted from the LED 504 in a particular direction. For example, in one implementation, the side wall 502 forms a parabolic shape that directs the light emitted from the LED 504. The LED 504 receives power and electrical connections through the mounting to the substrate 510.

The side wall 502 comprises an interior reflective surface 506. For example, the reflective surface 506 may be a polished surface or may comprise an additional reflective material or coating that is layered onto the side wall 502. The reflective surface 506 operates to reflect and focus the light emitted from the LED 504 to form a particular beam pattern. In one implementation, the height 512 and shape of the side wall 502 is used to control the tightness or direction of the resulting beam pattern. Thus, the cup 500 may comprise any desired shape or size.

An encapsulation material 508 (or encapsulant) covers the LED 504 and fills a portion of the reflective cup 500. In one implementation, the encapsulation 508 is a phosphor encapsulation material and is configured to cover the LED 504 but its overall height remains below the top edge of the cup 500. For example, the height of the encapsulant 508 is below the height 512 of the cup 500 by an amount shown at 516. The conversion of blue LED light to white light through the phosphor encapsulation 508 creates an inherent Lambertian pattern. Thus, in order to create the desired cup beam pattern, the conversion occurs within the directional cup 500 so that the light leaving the encapsulation 508 is then focused by the reflective side wall 502 to form the desired cup beam pattern.

In one implementation the encapsulation material 508 is a resin material whose purpose is to encapsulate and convert light. In another implementation, the encapsulation 508 is a lens if the size of the cup permits the use of a lens. In another implementation, the encapsulation 508 represents a phosphor coated LED. Thus, in various implementations, the encapsulation material 508 can comprise at least one material selected from a set comprising resin material, phosphor material, silicone material, epoxy material, an electrical isolation encapsulation material, a scattering encapsulation material, a protecting encapsulation material, and one or more layers of phosphor encapsulation material.

In one implementation, a directional LED array can be formed with a plurality of the directional cups 500 arranged or organized into an array configuration. In such an array, each directional cup includes one LED, but it is also possible to include multiple LEDs per cup. As will be shown, the directional cups can be configured into an array to form a variety of array beam patterns.

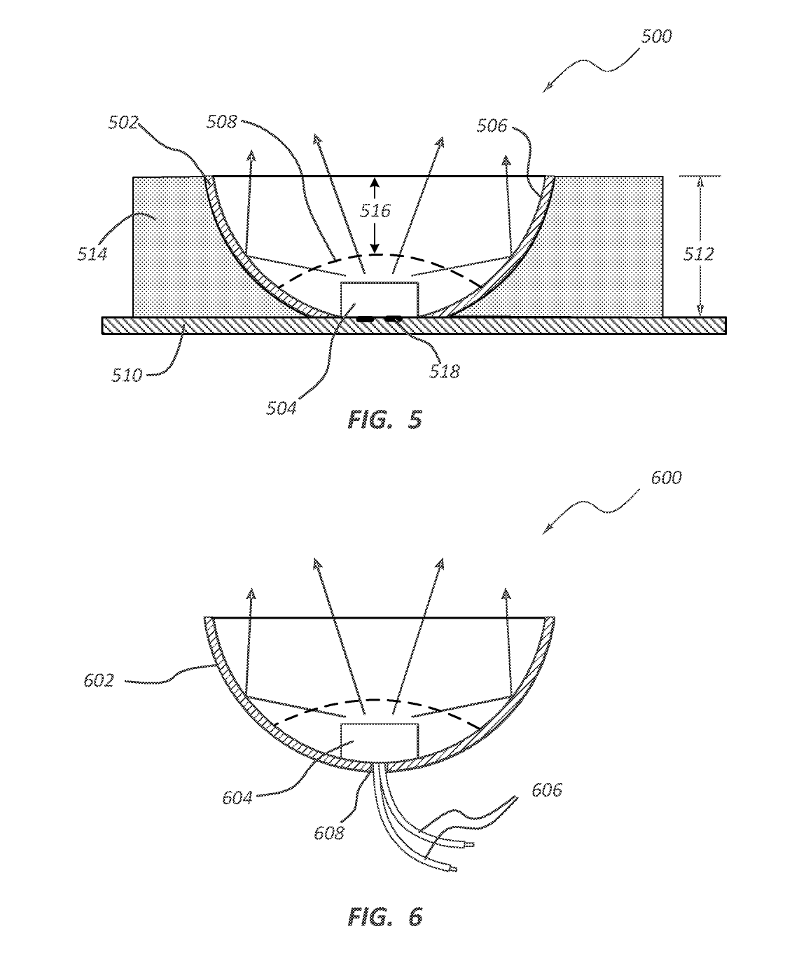

FIG. 6 shows a cross-sectional side view of an exemplary directional cup 600. The directional cup 600 is configured without the use of a substrate. For example, an LED 604 is mounted on a base or bottom surface inside the cup 600. In one implementation, the cup 600 includes side wall 602 and an opening 608 at the bottom surface to allow the LED 604 to be connected to electrical connections, such as wires 606.

In one implementation, a directional array can be formed using a plurality of the cups 600. The cups can be individually and directionally targeted to create desired beam patterns. For example, each cup can be shaped to direct light from its associated LED in any desired direction. This allows for specific beam patterns to be created by an array of such cups properly aligned. For example, the directional array could be configured to create a rectangular roadway light pattern or any other desired beam pattern.

### Cup Construction

In various implementations, the directional cups can be constructed in one or more of the following ways.
1. Produced as one or more cups within a substrate. For example, referring to FIG. 5, the cup 500 is constructed from an aluminum substrate layer; however, it is also possible to construct the cup 500 from silicone, plastic, composite materials, ceramic, copper or other materials. Once the substrate is formed, one or more cups can be molded, punched, formed, etched, drilled out or dug out from substrate. The cups are formed with a flat or approximately flat surface to allow an LED to be attached, for instance, with epoxy or other attachment means.
2. Produced as one or more cups that can be attached to a substrate. For example, directional cups can be produced separately and attached to a substrate or provided as a stand alone cup. For example, referring to FIG. 4, the cups 402, 404, and 406 are formed separately and attached to the substrate 408. Referring to FIG. 6, the cup 600 is formed as a stand alone directional cup that can comprise an LED mounted to an internal surface. In various implementations, the cups can be stamped, molded, shaped or formed, and comprise a mounting surface for mounting an LED or comprise an opening or cut away to allow an LED to extend or protrude into the cup to emit light.

### Cup Materials

In various implementations, the directional cups can be formed from materials such as aluminum, silver, silicone, plastic, ceramic, copper, composite materials or other materials.

### Reflective Surface

In various implementations, the reflective surfaces of the directional cups can be formed by polishing, texturing, coating, painting, layering with reflective materials such as TiO₂, or other techniques. The reflective surface may also comprise materials with electrical properties such as silver or aluminum. Thus, in one implementation, the cup surfaces themselves comprise electrical contacts that provide signal connections to the LEDs mounted within.

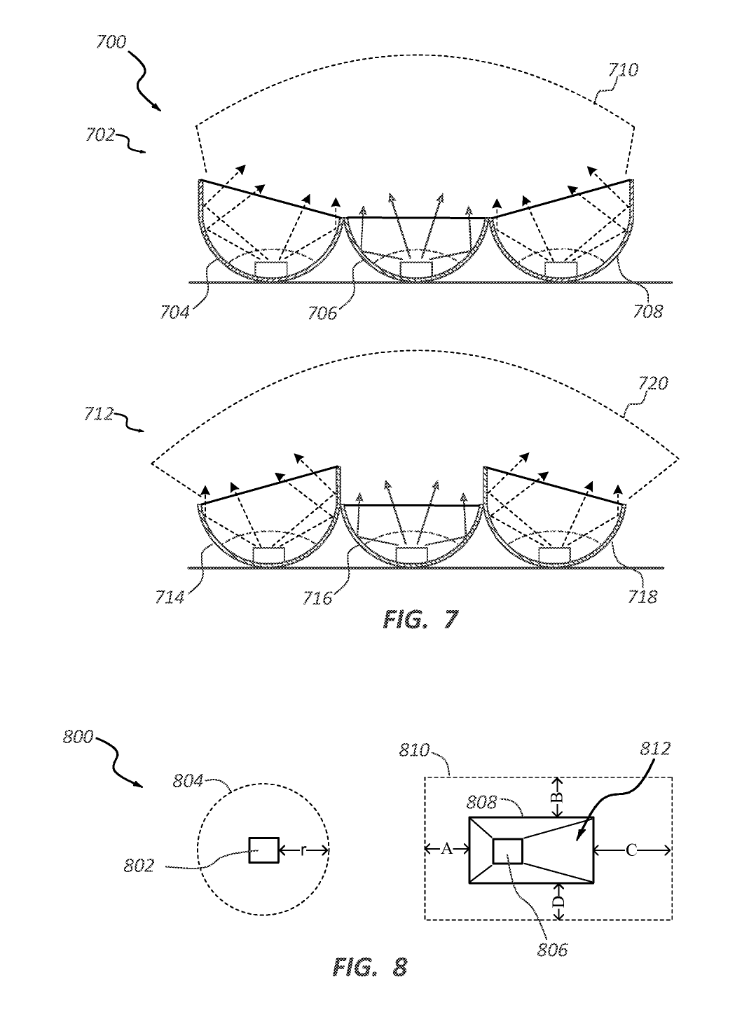

FIG. 7 shows two exemplary directional cup arrays 700. A first array 702 comprises directional cups 704, 706, and 708. The directional cups of the first array 702 are configured to form a tight array beam pattern 710. For example, the cups 704 and 708 have side walls and associated reflective surfaces that are configured to direct light inward toward the center thus forming the tight array beam pattern 710.

A second array implementation 712 comprises directional cups 714, 716, and 718. The directional cups of the second array 712 are configured to form a wide array beam pattern 720. For example, the cups 714 and 718 have side walls and associated reflective surfaces that are configured to direct light outward away from the center thus forming the wide array beam pattern 720.

Therefore, by configuring the cup geometry and LED locations within each cup, as illustrated by the directional arrays shown in FIG. 7, it is possible to form any desired illumination or array beam pattern.

FIG. 8 shows an exemplary cup beam pattern associated with an exemplary directional cup. For example, a top view of an exemplary directional cup 808 is shown. The cup 808 comprises LED 806 at its base. The cup 808 also comprises side walls shown generally at 812 that form a rectangular shape. The side walls also comprise reflective interior surfaces.

When the LED 806 is energized, light emitted from the LED 806 is directed and reflected off the side walls 812 to form the cup beam pattern 810. The directional cup 808 is configured to form the cup beam pattern 810 to provide the dimensions A, B, C and D as shown. Thus, by configuring the directional cup 808 to have a particular shape, side wall height, configuration, and appropriate location of the LED 806, it is possible to set the dimensions A, B, C and D of the emitted light to generate any desired cup beam pattern.

In contrast, a typical LED 802 generates a simple circular beam pattern 804 as shown. Typically, this circular pattern has a radius “r” that is related to the light output of the LED 802.

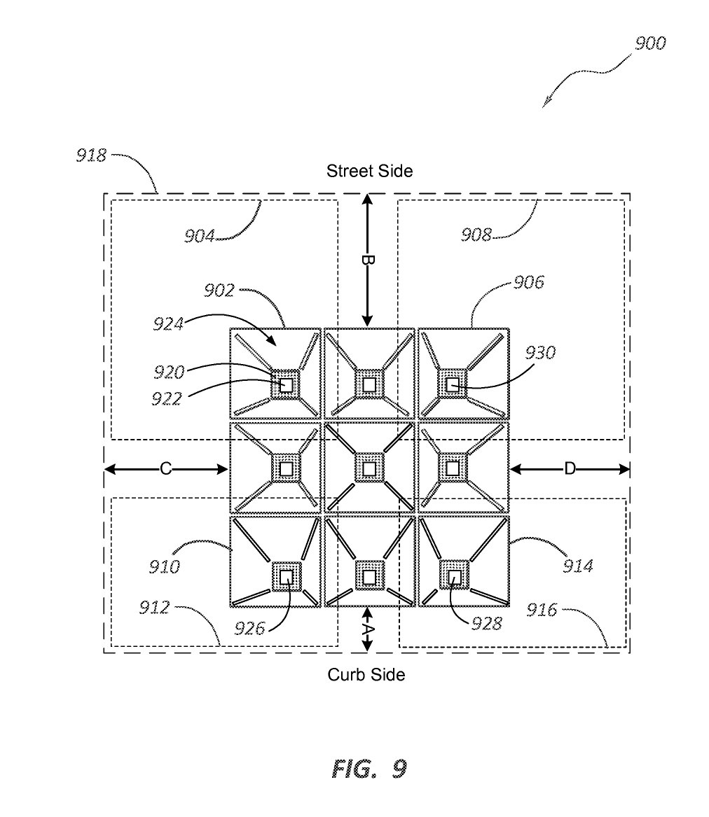

FIG. 9 shows an exemplary directional cup array 900. For example, the array 900 is suitable for use in a roadway light. In such an implementation, the array 900 is mounted in a lamp fixture and extended above the roadway by a post located near a roadway curb. As illustrated in FIG. 9, the roadway light positions the array 900 close to the curb.

The array 900 comprises a 3×3 arrangement of directional cups and associated LEDs. Each of the directional cups comprises an electrical connection mechanism to couple electrical signals to the one or more LEDs included in each cup. Each directional cup is configured to produce a desired cup beam pattern. For example, each cup is configured similarly to cup 902 to have a shape formed by side walls comprising at least one reflective surface 924, light emission location 920 comprising at least one LED 922 all configured to produce a particular cup beam pattern 904. For example, the cups 910, 914, and 906 comprises LEDs 926, 928 and 930, respectively. When the cup beam patterns produced by all the directional cups of the array 900 are combined, a resulting array beam pattern 918 is produced. For example, the resulting array beam pattern 918 has dimensions A, B, C, D with respect to the array 900.

To illustrate how the cup beam patterns produced by the directional cups combine to form the resulting array beam pattern 918, a directional cup 902 is configured to produce cup beam pattern 904. Similarly, cup 906 produces cup beam pattern 908, cup 910 produces cup beam pattern 912 and cup 914 produces cup beam pattern 916. For clarity, the beam patterns of the remaining cups in the array 900 are not shown in FIG. 9, however; the combination of the cup beam patterns from all the cups produces the resulting array beam pattern 918. The resulting array beam pattern 918 has dimension A which is relatively short and results in illuminating the roadway up to the curb. The resulting array beam pattern 918 also has dimensions C and D which illuminate a particular length of the roadway. The resulting array beam pattern 918 also has dimension B which illuminates a particular width of the roadway.

Thus, the array 900 is operable to form a rectangular array beam pattern to illuminate a roadway. It should be noted that the directional cups of the array 900 can be modified or arranged to form any desired array beam pattern, for instance, the resulting array beam pattern may be selected from a set of beam patterns comprising round, oval, elliptical, square, triangular, roadway, rectangular and multisided beam patterns.

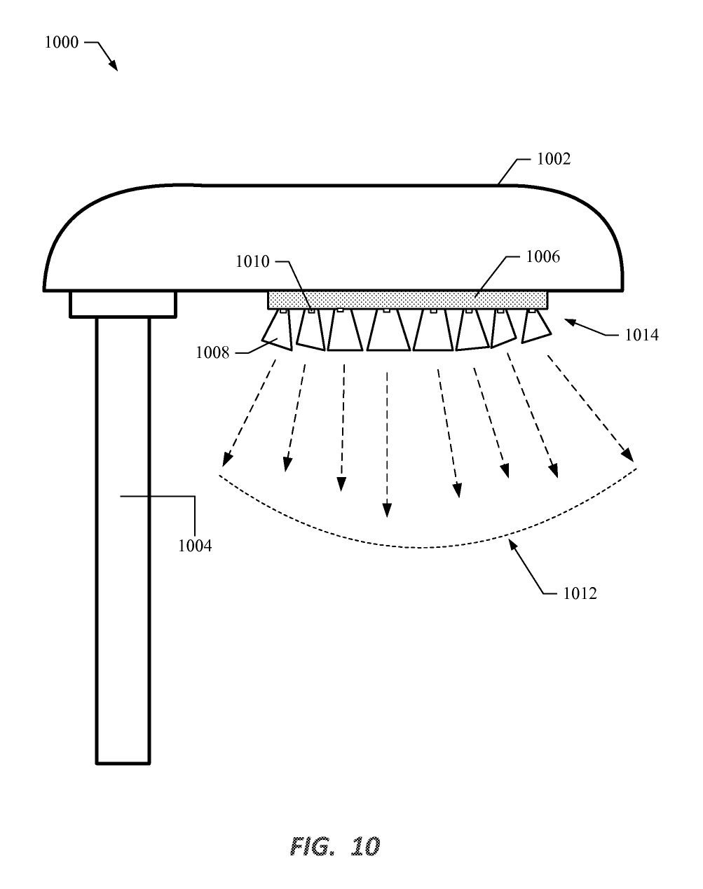

FIG. 10 shows an exemplary lighting fixture 1000 comprising a directional cup array 1014. For example, the lighting fixture 1000 is suitable for use as a roadway light. In one implementation, the array 1014 is the array 900 shown in FIG. 9. The array 1014 is mounted in a lamp 1002 that is extended above a roadway by a post 1004 located near a roadway curb. For example, the post 1004 positions the lamp 1002 and array 1014 to illuminate the roadway with a desired beam pattern.

The array 1014 comprises a substrate 1006 onto which is mounted a plurality of directional cups, as illustrated at 1008. Within each cup at least one LED is mounted to the substrate 1006, as illustrated at 1010. The size, dimension, and shape of the cups along with the location of the LEDs within each cup are configured to generate a desired array beam pattern 1012. For example, the directional cup array 1014 is configured as described herein. It should be noted that the directional cup array 1014 can be configured to produce any desired array beam pattern.

The various aspects of this disclosure are provided to enable one of ordinary skill in the art to practice the present invention. Various modifications to aspects presented throughout this disclosure will be readily apparent to those skilled in the art, and the concepts disclosed herein may be extended to other applications. Thus, the claims are not intended to be limited to the various aspects of this disclosure, but are to be accorded the full scope consistent with the language of the claims. All structural and functional equivalents to the elements of the various aspects described throughout this disclosure that are known or later come to be known to those of ordinary skill in the art are expressly incorporated herein by reference and are intended to be encompassed by the claims.

Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

Accordingly, while aspects of a directional LED array have been illustrated and described herein, it will be appreciated that various changes can be made to the aspects without departing from their spirit or essential characteristics. Therefore, the disclosures and descriptions herein are intended to be illustrative, but not limiting, of the scope of the invention, which is set forth in the following claims.

1.-38. (canceled)

39. A directional light emitting diode (LED) array comprising:
a plurality of LEDs; and
a plurality of cups coupled to the plurality of LEDs and configured to direct light emitted from the plurality of LEDs into a resulting array beam pattern, wherein each cup directs light from one or more LEDs to form the resulting array beam pattern.

40. The array of claim 39, wherein each cup comprises one or more side walls forming a selected cup geometry that is configured to reflect the light to produce a cup beam pattern that forms part of the resulting array beam pattern.

41. The array of claim 40, wherein the one or more side walls comprises at least one reflective surface.

42. The array of claim 40, wherein the selected cup geometry comprises at least one geometry selected from a set of geometries comprising round, oval, elliptical, parabolic, square, triangular, spherical, and multisided geometries.

43. The array of claim 39, wherein each cup comprises a light emission location where the one or more LEDs emit light into the cup.

44. The array of claim 43, wherein the light emission location is located on a bottom surface of each cup.

45. The array of claim 44, wherein the one or more LEDs are mounted at the light emission location associated with each cup.

46. The array of claim 43, wherein the light emission location is an opening at the bottom surface of each cup.

47. The array of claim 46, wherein the one or more LEDs protrude through the opening at the bottom surface of each cup.

48. The array of claim 39, further comprising an encapsulant covering the one or more LEDs associated with each cup.

49. The array of claim 48, wherein each encapsulant comprises a height that is less than a height of its respective cup.

50. The array of claim 48, wherein the encapsulant comprises at least one material selected from a set comprising resin, phosphor, silicone, epoxy, an electrical isolation encapsulation material, a scattering encapsulation material, a protecting encapsulation material, and one or more layers of phosphor encapsulation material.

51. The array of claim 39, further comprising a mounting surface configured to mount each cup to a substrate.

52. The array of claim 39, wherein each of the plurality of cups comprises electrical connections to couple electrical signals to the one or more LEDs.

53. The array of claim 39, wherein the resulting array beam pattern is selected from a set of beam patterns comprising round, oval, elliptical, square, triangular, roadway, rectangular and multisided beam patterns.

54. A lighting device comprising:
a lighting fixture; and
a cup array coupled to the lighting fixture and comprising:
a plurality of LEDs; and
a plurality of cups coupled to the plurality of LEDs and configured to direct light emitted from the plurality of LEDs into a resulting array beam pattern, wherein each cup directs light from one or more LEDs to form the resulting array beam pattern.

55. The device of claim 54, wherein each cup comprises one or more side walls to form a selected cup geometry that is configured to reflect the light to produce a cup beam pattern that forms part of the resulting array beam pattern.

56. The device of claim 55, wherein the one or more side walls comprises at least one reflective surface.

57. The device of claim 55, wherein the selected cup geometry comprises at least one geometry selected from a set of geometries comprising round, oval, elliptical, parabolic, square, triangular, spherical, and multisided geometries.

58. The device of claim 54, wherein each cup comprises a light emission location where the one or more LEDs emit light into the cup.

59. The device of claim 58, wherein the light emission location is located on a bottom surface of each cup.

60. The device of claim 59, wherein the one or more LEDs are mounted at the light emission location associated with each cup.

61. The device of claim 58, wherein the light emission location is an opening at the bottom surface of each cup.

62. The device of claim 61, wherein the one or more LEDs protrude through the opening at the bottom surface of each cup.

63. The device of claim 54, further comprising an encapsulant covering the one or more LEDs associated with each cup.

64. The device of claim 63, wherein each encapsulant comprises a height that is less than a height of its respective cup.

65. The device of claim 63, wherein the encapsulant comprises at least one material selected from a set comprising resin, phosphor, silicone, epoxy, an electrical isolation encapsulation material, a scattering encapsulation material, a protecting encapsulation material, and one or more layers of phosphor encapsulation material.

66. The device of claim 54, further comprising a mounting surface configured to mount each cup to a substrate.

67. The device of claim 54, wherein each of the plurality of cups comprises electrical connections to couple electrical signals to the one or more LEDs.

68. The device of claim 54, wherein the resulting array beam pattern is selected from a set of beam patterns comprising round, oval, elliptical, square, triangular, roadway, rectangular and multisided beam patterns.

69. A cup apparatus comprising:
a plurality of cups configured to direct light to form a resulting array beam pattern, wherein each cup directs light from one or more LEDs to form the resulting array beam pattern; and
one or more mounting surfaces disposed on the plurality of cups, wherein the one or more mounting surfaces are configured to mount the plurality of cups in a position to receive the light from the one or more LEDs.

70. The apparatus of claim 69, wherein each cup comprises one or more side walls to form a selected cup geometry that is configured to reflect the light to produce a cup beam pattern that forms part of the resulting array beam pattern.

71. The apparatus of claim 70, wherein the one or more side walls comprises at least one reflective surface.

72. The apparatus of claim 70, wherein the selected cup geometry comprises at least one geometry selected from a set of geometries comprising round, oval, elliptical, parabolic, square, triangular, spherical, and multisided geometries.

73. The apparatus of claim 69, wherein each cup comprises a light emission location where the one or more LEDs emit light into the cup.

74. The apparatus of claim 73, wherein the light emission location is an opening at a bottom surface of each cup.

75. The apparatus of claim 74, wherein the one or more LEDs protrude through the opening at the bottom surface of each cup.

76. The apparatus of claim 69, wherein the resulting array beam pattern is selected from a set of beam patterns comprising round, oval, elliptical, square, triangular, roadway, rectangular and multisided beam patterns.
